(19) United States
(12) Patent Application Publication
(10) Pub. No.: US 2026/0348807 A1
(43) Pub. Date: Nov. 5, 2026

(54) MARSHALL COMPACTION METHOD AND SYSTEM FOR ASPHALT MIXTURE, MANUFACTURING METHOD AND SYSTEM FOR ASPHALT MIXTURE, DEVICE, AND MEDIUM

(71) Applicants: SHANGHAI ROAD AND BRIDGE (GROUP) CO., LTD., Shanghai (CN); SHANGHAI URBAN CONSTRUCTION ROAD ENGINEERING CO., LTD, Shanghai (CN); SHANGHAI CHENGJIAN NICHIREKI SPECIAL ASPHALT CO., LTD, Shanghai (CN)

(72) Inventors: Zhiqiang CHENG, Shanghai (CN); Shengjia XIE, Shanghai (CN); Qingqing LU; De ZHANG, Shanghai (CN); Haichun LE, Shanghai (CN); Jian LI, Shanghai (CN); Ming CAI, Shanghai (CN); Xiaowei NIU, Shanghai (CN); Wei WANG, Shanghai (CN); Qingbing LU, Shanghai (CN)

(21) Appl. No.: 19/107,569

(22) PCT Filed: Apr. 28, 2023
(86) PCT No.: PCT/CN2023/091670

§ 371 Date: Feb. 27, 2025

(30) Foreign Application Priority Data
Aug. 29, 2022 (CN) 202211042733.2

(51) Int. Cl. G01N 3/08; C08L 95/00

(52) U.S. Cl. CPC G01N 3/08; C08L 95/00

(57) ABSTRACT

A Marshall compaction method and system for an asphalt mixture, a manufacturing method and system for an asphalt mixture, a device, and a medium. According to the compaction method, the dynamic response parameters of the asphalt mixture are obtained, and the target number of compactions is determined when the change of the dynamic response parameters is stable, so that the number of compactions is automatically and intelligently determined; moreover, the change of the dynamic response parameters directly reflects the internal compaction state of the asphalt mixture, so that the accuracy of determining the number of compactions is improved, and the situation that coarse aggregate is crushed due to overpressure or the porosity does not meet the requirement due to under pressure is avoided.

This application claims the priority of China Patent Application No. 2022110427332 filed on Aug. 29, 2022. This application refers to the full text of the above-mentioned China patent application.

### TECHNICAL FIELD

The invention relates to the technical field of road engineering, particularly a Marshall compaction method, manufacturing method, system, device and medium for asphalt mixture.

### TECHNICAL BACKGROUND

The Marshall design method is widely used in asphalt mixture design. Its specimen molding method is compaction molding. Although this molding method has certain limitations in simulating on-site compaction and correlation with road traffic volume, it is still one of the main methods for current asphalt mixture mixing ratio design due to its simplicity, applicability, and low device price.

During the compaction and molding process for asphalt mixture, there is a critical state of the internal skeleton structure of the system. Before reaching the critical state, the compaction effect can effectively increase the density of the asphalt mixture, and the compaction effect is significant; after reaching the critical state, the coarse aggregates contact each other after compaction to form a stable skeleton structure and interlock with each other. The coarse and fine aggregates and the coated asphalt share the load to reach a stable state. Further compaction will significantly increase the risk of aggregate breakage, change the original gradation of the mixture, and adversely affect its road performance. Therefore, the current Marshall specimen molding method using a fixed compaction number lacks a criterion for determining the internal compaction state of the mixture. Combined with relevant practical experience, the Marshall specimens compacted on both sides 75 times often result in the crushing of coarse aggregate due to excessive compaction, which on the one hand changes the original grading of the mixture, and on the other hand forms white material on the new crushed surface because it cannot be coated with asphalt, thus affecting the validity of the performance test results based on indoor formed Marshall specimens.

### SUMMARY OF THE INVENTION

The technical problem to be solved by the present invention is to overcome the defect in the prior art that compacting the specimen with a fixed number in the asphalt mixture mixing ratio design results in the crushing of coarse aggregate due to excessive compaction. The present invention provides a Marshall compaction method, manufacturing method, system, device and medium for asphalt mixture

The present invention solves the above technical problems through the following technical solutions:
the present invention provides a Marshall compaction method for asphalt mixture, wherein the compaction method comprises:
acquiring dynamic response parameters of the asphalt mixture during a Marshall compaction process;
wherein the dynamic response parameters are used for characterizing an internal state of the asphalt mixture corresponding to a compaction number;
judging whether the change degree of the dynamic response parameters is stable;
if so, determining the compaction number corresponding to when the change degree of the dynamic response parameters is stable as a target compaction number.

Preferably, the step of acquiring dynamic response parameters of the asphalt mixture during a Marshall compaction process comprises:
embedding a sensor in a preset position inside the asphalt mixture to acquire the dynamic response parameters of the asphalt mixture during the compaction process.

Preferably, the step of embedding a sensor in a preset position inside the asphalt mixture to acquire the dynamic response parameters of the asphalt mixture during the compaction comprises:
evenly burying a preset number of multi-index integrated intelligent sensors in the central axis of the asphalt mixture;
averaging the numerical values of the same kind of dynamic response parameters respectively acquired by the preset number of multi-index integrated intelligent sensors during the compaction process as the dynamic response parameters of the asphalt mixture during the compaction process.

Preferably, the step of judging whether the change degree of the dynamic response parameters is stable comprises:
determining the change rate of the dynamic response parameters according to the dynamic response parameters;
wherein the change rate of the dynamic response parameters is used for characterizing the change degree of the dynamic response parameters;
judging whether the change degree of the dynamic response parameters is stable according to the change rate of the dynamic response parameters and a preset stability threshold.

Preferably, the dynamic response parameters include contact stress, acceleration and rotation angle of internal particles of the asphalt mixture;
Determine the change rate of the dynamic response parameters according to the dynamic response parameters and the following formula:

$${R}_{n} = \frac{\vert Δσ \vert}{{SD}_{σ}} + \frac{\vert Δ a \vert}{S {D}_{a}} + \frac{\vert Δδ \vert}{S {D}_{δ}}$$

wherein n represents a current compaction number, Rₙ represents the change rate of the dynamic response parameters corresponding to compactions number n; SD_{σ}, SD_{α}, and SD_{δ} are the standard deviations of the peak values of contact stress σ, acceleration α and rotation angle δ of the last adjacent preset compaction respectively; Δσ, Δα and Δδ are the change values of peak values of contact stress σ, acceleration α and rotation angle δ of the last two adjacent compaction number respectively;
if so, the step of determining the compaction number corresponding to when the change degree of the dynamic response parameters is stable as the target compaction number comprises:
using the current compaction number as the target compaction number when the dynamic response parameters corresponding to the current compaction number is less than the stability threshold and the dynamic response parameters corresponding to the adjacent previous compaction number is greater than the stability threshold.

The present invention also provides a manufacturing method for asphalt mixture, wherein the manufacturing method comprises:
determining the pre-mixing ratio of the asphalt mixture;
determining the compaction number of the asphalt mixture according to the Marshall compaction method for asphalt mixture as described above; compacting the asphalt mixture according to the compaction number, and performing a performance test on the compacted asphalt mixture;
determining whether the pre-mixing ratio is a target mixing ratio according to whether a first index acquired by compaction treatment and a second index acquired by the performance test meet a standard.

The present invention also provides a Marshall compaction system for asphalt mixture, wherein the compaction system comprises:
a dynamic response parameters acquisition module used for acquiring the dynamic response parameters of the asphalt mixture during the Marshall compaction process;
wherein the dynamic response parameters are used for characterizing an internal state of the asphalt mixture corresponding to a compaction number;
a change degree judging module used for judging whether the change degree of the dynamic response parameters is stable;
a compaction number determination module used for determining the compaction number corresponding to when the change degree of the dynamic response parameters is stable as a target compaction number.

Preferably, the dynamic response parameters acquisition module is specifically used for embedding a sensor in a preset position inside the asphalt mixture to acquire the dynamic response parameters of the asphalt mixture during the compaction process.

Preferably, the dynamic response parameters acquisition module is specifically used for evenly burying a preset number of multi-index integrated intelligent sensors in the central axis of the asphalt mixture;
the dynamic response parameters acquisition module is specifically used for averaging the numerical values of the same kind of dynamic response parameters respectively acquired by the preset number of multi-index integrated intelligent sensors during the compaction process as the dynamic response parameters of the asphalt mixture during the compaction process.

Preferably, the change degree judging module is specifically used for determining the change rate of the dynamic response parameters according to the dynamic response parameters;
wherein the change rate of the dynamic response parameters is used for characterizing the change degree of the dynamic response parameters;
the change degree judging module is specifically used for judging whether the change degree of the dynamic response parameters is stable according to the change rate of the dynamic response parameters and a preset stability threshold.

Preferably, the dynamic response parameters include contact stress, acceleration and rotation angle of internal particles of the asphalt mixture;
the change degree judging module is specifically used for determining the change rate of the dynamic response parameters according to the dynamic response parameters and the following formula:

$${R}_{n} = \frac{\vert Δσ \vert}{{SD}_{σ}} + \frac{\vert Δ a \vert}{S {D}_{a}} + \frac{\vert Δδ \vert}{S {D}_{δ}}$$

wherein n represents a current compaction number, Rₙ represents the change rate of the dynamic response parameters corresponding to compaction number n; SD_{σ}, SD_{α} and SD_{δ} are the standard deviations of the peak values of contact stress σ, acceleration α and rotation angle δ of the last adjacent preset compaction respectively; Δσ, Δα and Δδ are the change values of peak values of contact stress σ, acceleration α and rotation angle δ of the last two adjacent compaction number respectively;
the compaction number determination module is specifically used for using the current compaction number as the target compaction number when the dynamic response parameters corresponding to the current compaction number is less than the stability threshold and the dynamic response parameters corresponding to the adjacent previous compaction number is greater than the stability threshold.

The present invention also provides a manufacturing system for asphalt mixture, wherein the manufacturing method comprises:
a pre-mixing ratio determining module used for determining the pre-mixing ratio of the asphalt mixture;
a compaction test module used for determining a compaction number of the asphalt mixture according to the Marshall compaction system for asphalt mixture as described above, performing compaction treatment on the asphalt mixture according to the compaction number, and performing a performance test on the compacted asphalt mixture;
an index analysis module used for determining whether the pre-mixing ratio is a target mixing ratio according to whether a first index acquired by compaction treatment and a second index acquired by the performance test meet a standard.

The present invention also provides an electronic device, wherein comprises: a memory, a processor, and a computer program stored in the memory and executable on the processor, wherein when the processor executes the computer program, the Marshall compaction method or the manufacturing method for asphalt mixture as described above is implemented.

The present invention also provides a computer-readable storage medium, wherein a computer program is stored thereon, wherein when the computer program is executed by a processor, the Marshall compaction method for asphalt mixture or the manufacturing method for asphalt mixture as described above is implemented.

The positive and progressive effects of the present invention are:

The Marshall compaction method for asphalt mixture provided by the present invention acquires dynamic response parameters used for characterizing the internal state of the asphalt mixture corresponding to the compaction number, and determines the target compaction number when the change degree of the dynamic response parameters is stable, thereby automatically and intelligently determining the compaction number of the asphalt mixture. The change degree of the dynamic response parameters of the internal state of the asphalt mixture corresponding to the compaction number directly reflects the compaction state inside the asphalt mixture, which is more accurate than indirectly determining the compaction state through external parameters (such as the acceleration response of the compaction hammer), thereby improving the accuracy of determining the compaction number of asphalt mixtures with different mixing ratios and different grading types, avoiding the crushing of coarse aggregate due to over-pressing or the porosity failing to meet the requirements due to under-pressing, and improving the quality of the asphalt mixture.

### BRIEF DESCRIPTION OF THE DRAWINGS

FIG. 1 is the first flowchart of the Marshall compaction method for asphalt mixture in embodiment 1 of the present invention.

FIG. 2 is a second flow chart of the Marshall compaction method for asphalt mixture in embodiment 1 of the present invention.

FIG. 3 is a schematic diagram of the embedding position of the intelligent sensor and compaction method in embodiment 1 of the present invention.

FIG. 4 is a graph showing the test results of the internal temperature of the mixture in embodiment 1 of the present invention.

FIG. 5 is a flow chart of the manufacturing method for asphalt mixture in embodiment 2 of the present invention.

FIG. 6 is a schematic diagram of the structure of the Marshall compaction system for asphalt mixture in embodiment 3 of the present invention.

FIG. 7 is a schematic diagram of the structure of the production system for asphalt mixture in embodiment 4 of the present invention.

FIG. 8 is a schematic diagram of the structure of an electronic device in embodiment 5 of the present invention.

### DETAILED DESCRIPTION

The present invention is further described below by way of embodiments, but the present invention is not limited to the scope of the embodiments.

### Embodiment 1

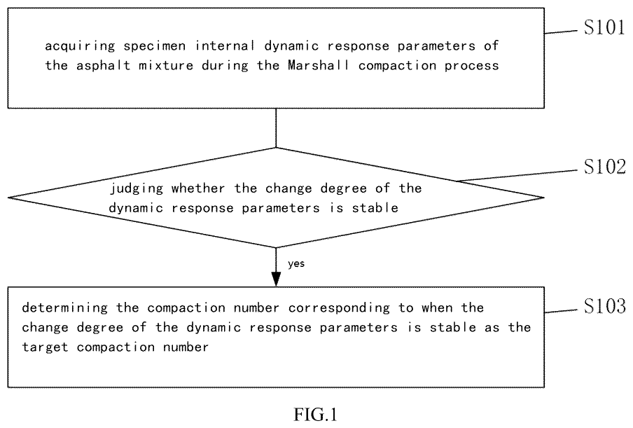

Please refer to FIG. 1, which is a first flow chart of the Marshall compaction method for asphalt mixture in this embodiment. Specifically, the compaction method includes:

S101. acquiring specimen internal dynamic response parameters of the asphalt mixture during the Marshall compaction process; wherein the dynamic response parameters are used for characterizing the internal state of the asphalt mixture corresponding to the compaction number. Specifically, compared with determining the compaction state of the asphalt mixture through external data or parameters, the dynamic response parameters in this embodiment characterize the internal state of the asphalt mixture corresponding to the compaction number, which more accurately reflects the compaction state of the asphalt mixture.

S102. judging whether the change degree of the dynamic response parameters is stable. Specifically, the response patterns of asphalt mixtures of different grading types (including but not limited to AC, SMA, OGFC, etc.) are different, as reflected by the changes in dynamic response parameters (including inter-particle contact stress σ, acceleration α and rotation angle δ) with the compaction number. Wherein, SMA (Stone Mastic Asphalt) refers to mastic asphalt crushed stone mixture, OGFC (Open-graded Friction Courses) refers to open-graded drainage wearing course mixture, and AC (Asphalt Concrete) refers to dense-graded asphalt mixture.

S103. if so, determining the compaction number corresponding to when the change degree of the dynamic response parameters is stable as the target compaction number. In an optional implementation, the critical compaction number at which the change rate of the dynamic response parameter is less than a preset stability threshold is used as the target compaction number.

In an optional implementation, step S101 comprises:
embedding a sensor in a preset position inside the asphalt mixture to acquire the dynamic response parameters of the asphalt mixture during the compaction process.

The following is further explained in conjunction with the Marshall compaction test.

This embodiment uses AC-20C asphalt mixture, the asphalt used is 70 #base asphalt, the oil-stone ratio is 4.5%, and the synthetic gradation of the mineral material is shown in Table 1.

TABLE 1

| Sieve Opening | | | | | | | | | | | | |
|---|---|---|---|---|---|---|---|---|---|---|---|---|
| Size /mm | 26.5 | 19 | 16 | 13.2 | 9.5 | 4.75 | 2.36 | 1.18 | 0.6 | 0.3 | 0.15 | 0.075 |
| Pass rate/% | 100 | 91.1 | 82.3 | 75.5 | 69.7 | 42.7 | 33.3 | 15.7 | 12.1 | 8.9 | 6.3 | 4.5 |

This embodiment uses a standard Marshall compactor, with a test mold inner diameter of 101.06 mm±0.2 mm (mm), a height of 87 mm, a base diameter of approximately 120.6 mm, a compacting hammer diameter of 98.5 mm±0.5 mm, a weight of 4536 g±9 g (g), and a drop height of 457.2 mm±1.5 mm.

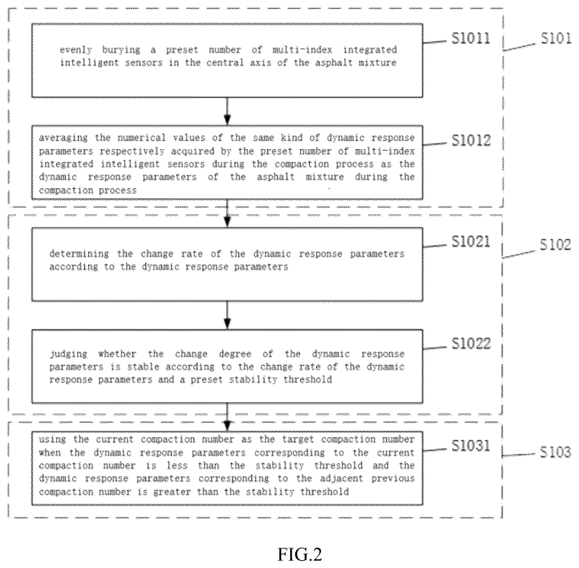

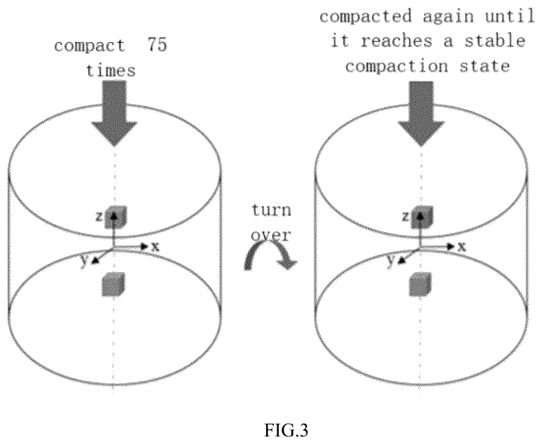

Please refer to FIG. 2, which is a second flow chart of the Marshall compaction method for asphalt mixture in this embodiment. Specifically, as shown in FIG. 2, the step of embedding a sensor at a preset position inside the asphalt mixture to acquire the dynamic response parameters of the asphalt mixture during the compaction process comprises:
S1011. evenly burying a preset number of multi-index integrated intelligent sensors in the central axis of the asphalt mixture. As shown in FIG. 3, multi-index integrated intelligent sensors are buried at positions ⅓ h and ⅔ h (h is the height of the Marshall specimen) on the central axis of the Marshall specimen to collect the contact stress σ, acceleration α, rotation angle δ, and temperature t of the internal particles of the asphalt mixture during the Marshall compaction process. A large amount of test data shows that compared with other burial locations, the test signals of multi-index integrated multi-source intelligent sensors buried at positions 11h and 22h on the central axis are the most stable and the test results are the best.

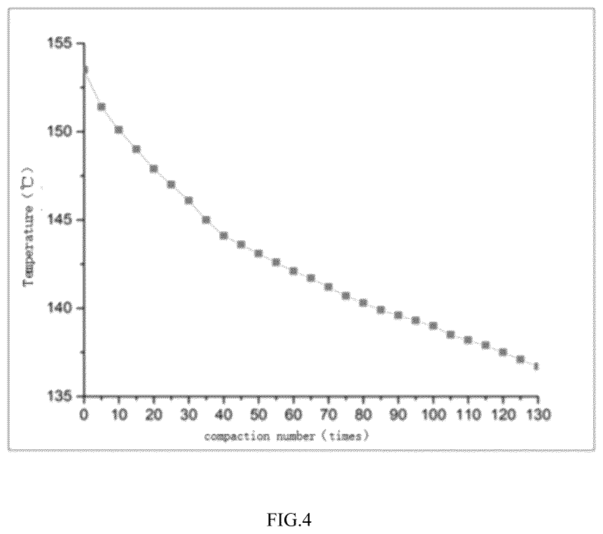

The specific method is: after checking that the Marshall compactor control box, compacting hammer and other devices are correct, prepare to bury the multi-index integrated intelligent sensor, add asphalt mixture to the Marshall test mold, and when it is added to one-third of the required amount, after preliminary leveling, bury the multi-index integrated intelligent sensor in the center of the test mold cross section; continue adding material, and when it is added to two-thirds of the required amount, after preliminary leveling, bury the multi-index integrated intelligent sensor in the center of the test mold cross section; add the remaining asphalt mixture. Then, compact the mixture on one side 75 times, and collect and record the contact stress σ, acceleration α, rotation angle δ, and temperature t between particles in the mixture during the Marshall compaction process in real time. The Marshall specimen compacted 75 times on one side is turned over and compacted again until it reaches a stable compaction state. The contact stress σ, acceleration α, rotation angle δ and temperature t between particles in the mixture during the Marshall compaction process are collected and recorded in real time, and the temperature results are shown in FIG. 4. Since the temperature is correlated with the contact stress σ between particles, the temperature value is measured at the same time as a reference.

S1012. averaging the numerical values of the same kind of dynamic response parameters respectively acquired by the preset number of multi-index integrated intelligent sensors during the compaction process as the dynamic response parameters of the asphalt mixture during the compaction process.

In an optional implementation, step S102 comprises:
S1021. determining the change rate of the dynamic response parameters according to the dynamic response parameters; wherein the change rate of the dynamic response parameters is used for characterizing a change degree of the dynamic response parameters.
S1022. judging whether the change degree of the dynamic response parameters is stable according to the change rate of the dynamic response parameters and a preset stability threshold.

In this embodiment, the dynamic response parameters include the contact stress, acceleration and rotation angle of the internal particles of the asphalt mixture; the change rate of the dynamic response parameters is determined according to the dynamic response parameters and the following formula:

$${R}_{n} = \frac{\vert Δσ \vert}{{SD}_{σ}} + \frac{\vert Δ a \vert}{S {D}_{a}} + \frac{\vert Δδ \vert}{S {D}_{δ}}$$

wherein n represents a current compaction number, Rₙ represents the change rate of the dynamic response parameters corresponding to compaction number n; SD_{σ}, SD_{α}, and SD_{δ} are the standard deviations of the peak values of contact stress σ, acceleration α and rotation angle δ of the last adjacent preset compaction respectively; Δσ, Δα and Δδ are the change values of peak values of contact stress σ, acceleration α and rotation angle δ of the last two adjacent compaction number respectively; Rₙ₋₁>ε and Rₙ<ε, are used as the conditions for the termination of Marshall compaction, wherein ε is a preset threshold, which is usually taken as 0.03.

Table 2 shows the test results of the dynamic response parameters of the particles inside the mixture during the Marshall compaction process in an experiment. When compacted 132 times, the dynamic response parameters tend to be stable. The dynamic response parameters measured by the two multi-index integrated intelligent sensors embedded in the Marshall compaction from 127 to 132 times are shown in the following table.

TABLE 2

| | compaction number/times | | | | | | | | | | | |
|---|---|---|---|---|---|---|---|---|---|---|---|---|
| test parameters | 127 | | 128 | | 129 | | 130 | | 131 | | 132 | |
| contact stress σ/KPa | 504.5 | 504.2 | 508.4 | 508.3 | 510.5 | 510.7 | 512.9 | 512.9 | 513.2 | 513.1 | 513.1 | 513.0 |
| | 503.9 | | 508.1 | | 510.8 | | 512.8 | | 512.9 | | 512.9 | |
| acceleration α/g | 3.1 | 3.1 | 3.5 | 3.6 | 4.0 | 3.9 | 4.2 | 4.2 | 4.2 | 4.4 | 4.3 | 4.4 |
| | 3.0 | | 3.7 | | 3.8 | | 4.1 | | 4.6 | | 4.5 | |
| rotation angle δ/° | 1.3 | 1.4 | 0.8 | 0.9 | 0.6 | 0.5 | 0.3 | 0.3 | 0.1 | 0.2 | 0.1 | 0.2 |
| | 1.4 | | 1.0 | | 0.4 | | 0.3 | | 0.3 | | 0.2 | |

In this embodiment, SD_{σ}, SD_{α}, and SD_{δ} are the standard deviations of the peak values of contact stress σ, acceleration α and rotation angle δ of the last five adjacent compaction number respectively; Δσ, Δα and Δδ are the change values of the peak values of contact stress σ, acceleration α and rotation angle δ measured in the last two adjacent compaction number respectively. R131=0.831 and R132=0.027 are calculated. Wherein taking the contact stress corresponding to compaction number 127 as an example, the values acquired by the two sensors are 504.5 KPa (kilopascals) and 503.9 KPa respectively, and the average value is 504.2 KPa.

Step S103 comprises:
S1031. using the current compaction number as the target compaction number when the dynamic response parameters corresponding to the current compaction number is less than the stability threshold and the dynamic response parameters corresponding to the adjacent previous compaction number is greater than the stability threshold. Specifically, R₁₃₁=0.831>0.03, R₁₃₂=0.027<0.03, that is, it is considered that the Marshall specimen reaches a stable compaction state when compacted 132 times, and the compaction is terminated, with 132 as the target compaction number.

Repeat the above steps and conduct another 3 groups of parallel tests, and the compaction termination numbers are 128, 131, and 126 respectively. The maximum value of compaction termination number 132 is taken as the Marshall compaction number of the AC-20C asphalt mixture molded in this embodiment.

The Marshall compaction method for asphalt mixture provided by the present invention acquires the dynamic response parameters of the asphalt mixture used for characterizing the internal state of the asphalt mixture corresponding to the compaction number, and determines the target compaction number when the change rate of the dynamic response parameters reaches a preset stability threshold, thereby automatically and intelligently determining the compaction number of the asphalt mixture. The change degree of the dynamic response parameters of the internal state of the asphalt mixture corresponding to the compaction number directly reflects the compaction state inside the asphalt mixture, which is more accurate than indirectly determining the compaction state through external parameters (such as the acceleration response of the compaction hammer), thereby improving the accuracy of determining the compaction number of asphalt mixtures with different proportions and different grading types, avoiding the crushing of coarse aggregate due to over-pressing or the porosity not meeting the requirements due to under-pressing, and improving the quality of the asphalt mixture.

### Embodiment 2

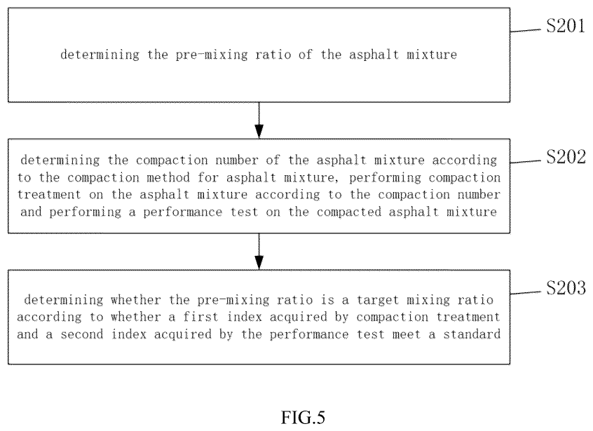

Please refer to FIG. 5, which is a flow chart of the manufacturing method for asphalt mixture in this embodiment.

Specifically, the production method comprises:
S201. determining the pre-mixing ratio of the asphalt mixture; specifically, this embodiment uses AC-20C asphalt mixture, the asphalt used is 70 #base asphalt, the oil-stone ratio is 4.5%, and the synthetic gradation of the mineral material is shown in Table 1.
S202, determining the compaction number of the asphalt mixture according to the Marshall compaction method for asphalt mixture in embodiment 1, performing compaction treatment on the asphalt mixture according to the compaction number and performing a performance test on the compacted asphalt mixture;
S203. determining whether the pre-mixing ratio is a target mixing ratio according to whether a first index acquired by compaction treatment and a second index acquired by the performance test meet a standard. The volume parameters and conventional performance of the AC-20C asphalt mixture acquired in step S202 are verified. The results are shown in Table 3. The Marshall test index (first index) and various road performance indexes (second index) all meet the requirements of the specification, indicating that the method is applicable and effective.

TABLE 3

| | | Test | | Specification | | |
|---|---|---|---|---|---|---|
| Test indexs | | results | | requirements | | Test methods |
| Marshall | Air Voids (VV) | 4.1% | | 3%~5% | | T 0705-2011 |
| Test | Voids in Mineral Aggregate(VMA) | 14.3% | | ≥13% | | T 0705-2011 |
| | Voids Filed with Asphalt(VFA) | 71% | | 65%~75% | | T 0705-2011 |
| | Marshall Stability (MS) | 9.2 | kN | ≥8 | kN | T 0709-2011 |
| | Flow Value (FL) | 3.1 | mm | 2~4 | mm | T 0709-2011 |
| Performance | Dynamic Stability (DS) | | | ≥1000 · mm⁻¹ | | T 0719-2011 |
| Indicators | Failure Strain (ε_{B}) | 2310 | με | ≥2000 | με | T 0715-2011 |

| | | | |
|---|---|---|---|
| Tensile Strength Ratio(TSR) | 79.8% | ≥75% | T 0729-2011 |
| Residual Marshall Stability | 83.2% | ≥80% | T 0709-2011 |

The manufacturing method for asphalt mixture provided in the present embodiment determines the compaction number of the asphalt mixture by utilizing the Marshall compaction method of the above-mentioned asphalt mixture, compacts the asphalt mixture according to the determined compaction number and performs a performance test on the compacted asphalt mixture. If the first index acquired by the compaction treatment and the second index acquired by the performance test both meet the standard, the pre-mixing ratio is determined to be the target mixing ratio. The target mixing ratio of the asphalt mixture is determined automatically and intelligently, thereby improving the accuracy of determining the compaction number of asphalt mixtures with different mixing ratios and different grading types, avoiding the crushing of coarse aggregate due to over-pressing or the porosity not meeting the requirements due to under-pressing, thereby improving the quality of the asphalt mixture.

### Embodiment 3

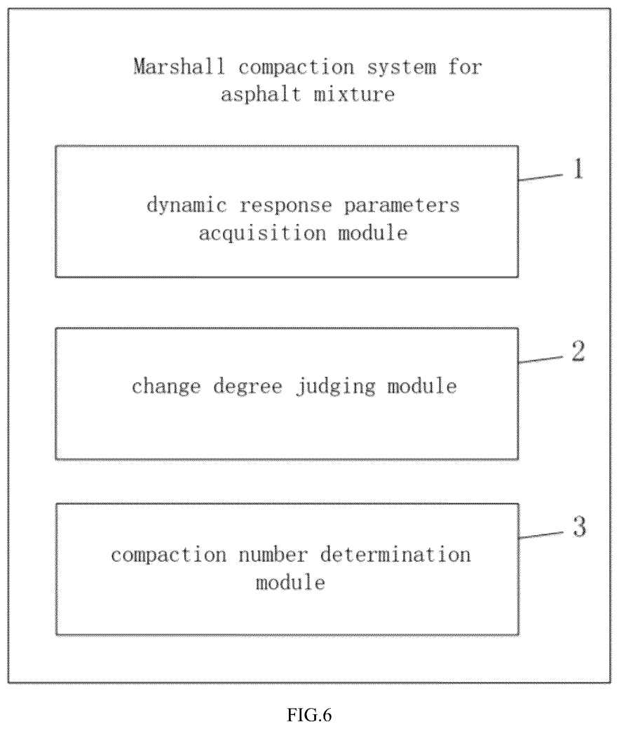

Please refer to FIG. 6, which is a schematic diagram of the structure of the Marshall compaction system for asphalt mixture in this embodiment. Specifically, the compaction system comprises:
The dynamic response parameter acquisition module 1 used for acquiring the internal dynamic response parameters of the asphalt mixture specimen during the Marshall compaction process; wherein the dynamic response parameters are used for characterizing the internal state of the asphalt mixture corresponding to the compaction number; specifically, compared with determining the compaction state of the asphalt mixture through external data or parameters, the dynamic response parameters in this embodiment characterize the internal state of the asphalt mixture corresponding to the compaction number, which more accurately reflects the compaction state of the asphalt mixture.
The change degree judging module 2 used for judging whether the change degree of the dynamic response parameters is stable; specifically, it is reflected by the change of the dynamic response parameters (including inter-particle contact stress σ, acceleration α and rotation angle δ) with the compaction number. The response patterns of asphalt mixtures of different grading types (including but not limited to AC, SMA, OGFC, etc.) are different. Wherein, SMA (Stone Mastic Asphalt) refers to mastic asphalt crushed stone mixture, OGFC (Open-graded Friction Courses) refers to open-graded drainage wearing course mixture, and AC (Asphalt Concrete) refers to dense-graded asphalt mixture.
The compaction number determination module 3 used for determining the compaction number corresponding to when the change degree of the dynamic response parameters is stable as target compaction number. In an optional implantation, the critical compaction number at which the dynamic response parameter change rate is less than a preset stability threshold is used as the target compaction number.

In an optional implementation, the dynamic response parameter acquisition module 1 is specifically used for embedding a sensor in a preset position inside the asphalt mixture to acquire the dynamic response parameters of the asphalt mixture during the compaction process.

The following is further explained in conjunction with the Marshall compaction test.

This embodiment uses AC-20C asphalt mixture, the asphalt used is 70 #base asphalt, the oil-stone ratio is 4.5%, and the synthetic gradation of the mineral material is shown in Table 1.

This embodiment uses a standard Marshall compactor, with a test mold inner diameter of 101.06 mm±0.2 mm (mm), a height of 87 mm, a base diameter of approximately 120.6 mm, a compacting hammer diameter of 98.5 mm±0.5 mm, a weight of 4536 g±9 g (g), and a drop height of 457.2 mm±1.5 mm.

Specifically, the dynamic response parameter acquisition module 1 is specifically used for evenly burying a preset number of multi-index integrated intelligent sensors in the central axis of the asphalt mixture; as shown in FIG. 3, the multi-index integrated intelligent sensors are buried at positions h and h (h is the height of the Marshall specimen) on the central axis of the Marshall specimen to collect the contact stress σ, acceleration α, rotation angle δ, and temperature t of the internal particles of the asphalt mixture during the Marshall compaction process. A large amount of test data shows that compared with other burial positions, burying the multi-index integrated multi-source intelligent sensor at positions ⅓ h and ⅔h on the central axis respectively has the most stable test signal and the best test result.

The specific method is: after checking that the Marshall compactor control box, compacting hammer and other devices are correct, prepare to bury the multi-index integrated intelligent sensor, add asphalt mixture to the Marshall test mold, and when it is added to one-third of the required amount, after preliminary leveling, bury the multi-index integrated intelligent sensor in the center of the test mold cross section; continue adding material, and when it is added to two-thirds of the required amount, after preliminary leveling, bury the multi-index integrated intelligent sensor in the center of the test mold cross section; add the remaining asphalt mixture. Then, compact the mixture on one side 75 times, and collect and record the contact stress σ, acceleration α, rotation angle δ, and temperature t between particles in the mixture during the Marshall compaction process in real time. The Marshall specimen compacted 75 times on one side is turned over and compacted again until it reaches a stable compaction state. The contact stress σ, acceleration α, rotation angle δ and temperature t between particles in the mixture during the Marshall compaction process are collected and recorded in real time. The temperature results are shown in FIG. 4. Since the temperature is correlated with the contact stress σ between particles, the temperature value is measured at the same time as a reference.

The dynamic response parameter acquisition module 1 is specifically used for averaging the numerical values of the same kind of dynamic response parameters respectively acquired by the preset number of multi-index integrated intelligent sensors during the compaction process as the dynamic response parameters of the asphalt mixture during the compaction process.

In an optional implantation, the change degree judging module 2 is specifically used for determining the change rate of dynamic response parameter according to the dynamic response parameter; wherein the change rate of dynamic response parameters is used for characterizing the change degree of the dynamic response parameters; the change degree judging module 2 is specifically used for judging whether the change degree of the dynamic response parameter is stable according to the change rate of the dynamic response parameters and a preset stability threshold.

In this embodiment, the dynamic response parameters include contact stress, acceleration and rotation angle of internal particles of the asphalt mixture; the change degree judging module 2 is specifically used for determining the change rate of dynamic response parameters according to the dynamic response parameters and the following formula:

$${R}_{n} = \frac{\vert Δσ \vert}{{SD}_{σ}} + \frac{\vert Δ a \vert}{S {D}_{a}} + \frac{\vert Δδ \vert}{S {D}_{δ}}$$

wherein n represents a current compaction number, Rₙ represents the change rate of the dynamic response parameters corresponding to compaction n; SDσ, SDα and SDδ are the standard deviations of the peak values of contact stress σ, acceleration α and rotation angle δ of the last adjacent preset compaction respectively; Δσ, Δα and Δδ are the change values of peak values of contact stress σ, acceleration α and rotation angle δ of the last two adjacent compaction number respectively; Rn-1>ε and Rn<ε are used as the conditions for the termination of Marshall compaction; wherein ε is the preset threshold, which is usually taken as 0.03.

Table 2 shows the test results of the dynamic response parameters of the particles inside the mixture during the Marshall compaction process in an experiment. When compacted 132 times, the dynamic response parameters tended to be stable. The dynamic response parameters measured by the two multi-index integrated intelligent sensors embedded in the Marshall compaction from 127 to 132 times are shown in Table 2.

In this embodiment, SD_{σ}, SD_{α}, and SD_{δ} are the standard deviations of the peak values of contact stress σ, acceleration α and rotation angle δ of the last five adjacent compaction number respectively; Δσ, Δα and Δδ are the change values in the peak values of contact stress σ, acceleration α and rotation angle δ measured in the last two adjacent compaction number respectively. R131=0.831 and R132=0.027 are calculated.

The compaction number determination module 3 is specifically used for using the current compaction number as the target compaction number when the dynamic response parameter corresponding to the current compaction number is less than the stability threshold and the dynamic response parameter corresponding to the previous adjacent compaction number is greater than the stability threshold. Specifically, R131=0.831>0.03, R132=0.027<0.03, that is, it is considered that the Marshall specimen reaches a stable compaction state when compacted 132 times, and the compaction is terminated, with 132 as the target compaction number.

The above operation is repeated to conduct another three groups of parallel tests, and the compaction termination numbers are 128, 131, and 126 respectively. The maximum value of compaction termination number 132 is taken as the Marshall compaction number of the AC-20C asphalt mixture molded in this embodiment.

The Marshall compaction system for asphalt mixture provided by the present invention acquires dynamic response parameters of the asphalt mixture used for characterizing the internal state of the asphalt mixture corresponding to the compaction number, and determines the target compaction number when the change rate of the dynamic response parameters reaches a preset stability threshold value, thereby automatically and intelligently determining the compaction number of the asphalt mixture. The change degree of the dynamic response parameters of the internal state of the asphalt mixture corresponding to the compaction number directly reflects the compaction state inside the asphalt mixture, which is more accurate than indirectly determining the compaction state through external parameters (such as the acceleration response of the compaction hammer), thereby improving the accuracy of determining the compaction number of asphalt mixtures with different mixing ratios and different grading types, avoiding the crushing of coarse aggregate due to over-pressing or the porosity not meeting the requirements due to under-pressing, and improving the quality of the asphalt mixture.

### Embodiment 4

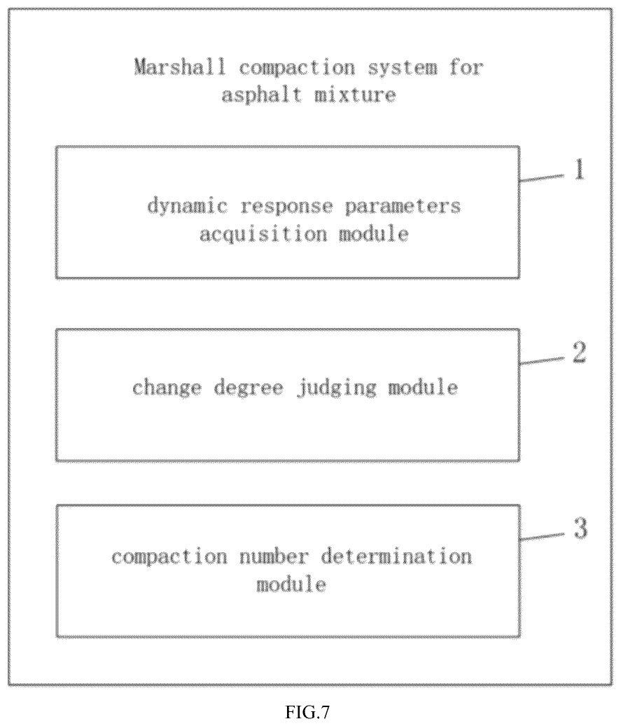

Please refer to FIG. 7, which is a schematic diagram of the structure of the production system for asphalt mixture in this embodiment. Specifically, the production system comprises:

The pre-mixing ratio determination module 4 used for determining the pre-mixing ratio of the asphalt mixture; specifically, this embodiment uses AC-20C asphalt mixture, the asphalt used is 70 #base asphalt, the oil-stone ratio is 4.5%, and the synthetic gradation of the mineral material is shown in Table 1.

The compaction test module 6 used for determining compaction number of the asphalt mixture according to the Marshall compaction system for asphalt mixture as described above, performing compaction treatment on the asphalt mixture according to the compaction number, and performing a performance test on the compacted asphalt mixture;

The index analysis module 6 used for determining whether the pre-mixing ratio is a target mixing ratio according to whether a first index acquired by compaction treatment and a second index acquired by the performance test meet a standard. The volume parameters and conventional performance of AC-20C asphalt mixture obtained by compaction test module 5 are verified. The results are shown in Table 3. The Marshall test index (first index) and various road performance indexes (second index) all meet the requirements of the specification, indicating that this method is applicable and effective.

The asphalt mixture production system provided in the present embodiment determines the compaction number of the asphalt mixture by utilizing the Marshall compaction system of the above-mentioned asphalt mixture, compacts the asphalt mixture according to the determined compaction number, and performs a performance test on the compacted asphalt mixture. If the first index obtained by the compaction treatment and the second index obtained by the performance test both meet the standard, the pre-mixing ratio is determined to be the target mixing ratio. The target mixing ratio of the asphalt mixture is determined automatically and intelligently, thereby improving the accuracy of determining the compaction number of asphalt mixtures with different mixing ratios and different grading types, avoiding the crushing of coarse aggregate due to over-pressing or the porosity not meeting the requirements due to under-pressing, thereby improving the quality of the asphalt mixture.

### Embodiment 5

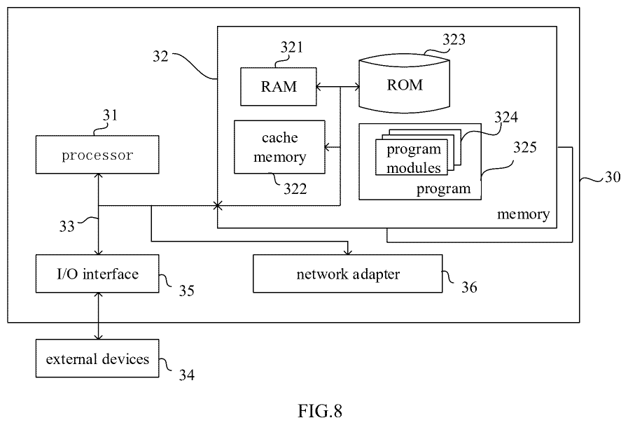

FIG. 8 is a schematic diagram of the structure of an electronic device in embodiment 5 of the present invention. An electronic device, wherein comprises: a memory, a processor, and a computer program stored in the memory and executable on the processor, wherein when the processor executes the computer program, the Marshall compaction method for asphalt mixture in embodiment 1 or the manufacturing method for asphalt mixture in embodiment 2 is implemented. The electronic device 30 shown in FIG. 8 is merely an example and should not limit the functions and scope of use of the embodiments of the present invention.

As shown in FIG. 8, the electronic device 30 may be in the form of a general-purpose computing device, for example, it may be a server device. The components of the electronic device 30 may include, but are not limited to: the at least one processor 31 mentioned above, the at least one memory 32 as described above, and a bus 33 connecting different system components (including the memory 32 and the processor 31).

The bus 33 includes a data bus, an address bus, and a control bus.

The memory 32 may include a volatile memory, such as a random access memory (RAM) 321 and/or a cache memory 322, and may further include a read-only memory (ROM) 323.

The memory 32 may also include a program/utility 325 having a set (at least one) of program modules 324, such program modules 324 including but not limited to: an operating system, one or more application programs, other program modules, and program data, each of which or some combination may include an implementation of a network environment.

The processor 31 executes various functional applications and data processing by running the computer program stored in the memory 32, such as the Marshall compaction method of the asphalt mixture of embodiment 1 or the manufacturing method for asphalt mixture of embodiment 2 of the present invention.

The electronic device 30 may also communicate with one or more external devices 34 (e.g., keyboards, pointing devices, etc.). Such communication may occur via an input/output (I/O) interface 35. Furthermore, the model generating device 30 can also communicate with one or more networks (eg, a local area network (LAN), a wide area network (WAN) and/or a public network, such as the Internet) through a network adapter 36. As shown, the network adapter 36 communicates with other modules of the model generating device 30 via the bus 33. It should be understood that although not shown in the figure, other hardware and/or software modules can be used in conjunction with the model generated device 30, including but not limited to: microcode, device drivers, redundant processors, external disk drive arrays, RAID (disk array) systems, tape drives, and data backup storage systems.

It should be noted that although several units/modules or sub-units/modules of the electronic device are mentioned in the above detailed description, such division is merely exemplary and not mandatory. In fact, according to embodiments of the present invention, the features and functions of two or more units/modules described above may be embodied in one unit/module. On the contrary, the features and functions of one unit/module described above may be further divided into multiple units/modules to be embodied.

### Embodiment 6

This embodiment provides a computer-readable storage medium having a computer program stored thereon. When the program is executed by a processor, the Marshall compaction method for asphalt mixture of embodiment 1 or the manufacturing method for asphalt mixture of embodiment 2 is implemented.

The readable storage medium may include but is not limited to: a portable disk, a hard disk, a random access memory, a read-only memory, an erasable programmable read-only memory, an optical storage device, a magnetic storage device or any suitable combination of the above.

In a possible implementation, the present invention can also be implemented in the form of a program product, which includes a program code. When the program product is run on a terminal device, the program code is used to enable the terminal device to execute the Marshall compaction method for asphalt mixture in embodiment 1 or the manufacturing method for asphalt mixture in embodiment 2.

Wherein the program code for executing the present invention can be written in any combination of one or more programming languages, and the program code can be executed completely on the user device, partially on the user device, as an independent software package, partially on the user device and partially on a remote device, or completely on the remote device.

Although specific embodiments of the present invention are described above, those skilled in the art will appreciate that this is only for illustration and the protection scope of the present invention is defined by the appended claims. Those skilled in the art may make various changes or modifications to these implementations without departing from the principle and essence of the present invention, but these changes and modifications are all within the protection scope of the present invention.

1. A Marshall compaction method for asphalt mixture, wherein the compaction method comprises:
acquiring dynamic response parameters of the asphalt mixture during a Marshall compaction process;
wherein the dynamic response parameters are used for characterizing an internal state of the asphalt mixture corresponding to a compaction number;
judging whether a change degree of the dynamic response parameters is stable;
if so, determining the compaction number corresponding to when the change degree of the dynamic response parameters is stable as a target compaction number.

2. The compaction method according to claim 1, wherein the step of acquiring dynamic response parameters of the asphalt mixture during a Marshall compaction process comprises:
embedding a sensor in a preset position inside the asphalt mixture to acquire the dynamic response parameters of the asphalt mixture during the compaction process.

3. The compaction method according to claim 2, wherein the step of embedding a sensor in a preset position inside the asphalt mixture to acquire the dynamic response parameters of the asphalt mixture during the compaction process comprises:
evenly burying a preset number of multi-index integrated intelligent sensors in the central axis of the asphalt mixture to acquire at least one kind of dynamic response parameters of the asphalt mixture during the compaction process;
averaging the numerical values of the same kind of dynamic response parameters respectively acquired by the preset number of multi-index integrated intelligent sensors during the compaction process as the dynamic response parameters of the asphalt mixture during the compaction process.

4. The compaction method according to claim 1, wherein the step of judging whether the change degree of the dynamic response parameters is stable comprises:
determining a change rate of the dynamic response parameters according to the dynamic response parameters;
wherein the change rate of the dynamic response parameters is used for characterizing the change degree of the dynamic response parameters;
judging whether the change degree of the dynamic response parameters is stable according to the change rate of the dynamic response parameters and a preset stability threshold.

5. The compaction method according to claim 4, wherein the dynamic response parameters include contact stress, acceleration and rotation angle of internal particles of the asphalt mixture;
determining the change rate of the dynamic response parameters according to the dynamic response parameters and the following formula:
$${R}_{n} = \frac{\vert Δσ \vert}{{SD}_{σ}} + \frac{\vert Δ a \vert}{S {D}_{a}} + \frac{\vert Δδ \vert}{S {D}_{δ}}$$
wherein n represents current compaction number, Rₙ represents the change rate of the dynamic response parameters corresponding to compaction number n; SD_{σ}, SD_{α}, and SD_{δ} are the standard deviations of the peak values of contact stress σ, acceleration α and rotation angle δ of the last adjacent preset compaction respectively; Δσ, Δα and Δδ are the change values of peak values of contact stress σ, acceleration α and rotation angle δ of the last two adjacent compaction number respectively;
if so, the step of determining the compaction number corresponding to when the change degree of the dynamic response parameters is stable as a target compaction number comprises:
using a current compaction number as the target compaction number when the dynamic response parameters corresponding to the current compaction number is less than the stability threshold and the dynamic response parameters corresponding to the adjacent previous compaction number is greater than the stability threshold.

6. A manufacturing method for asphalt mixture, wherein the manufacturing method comprises:
determining a pre-mixing ratio of the asphalt mixture;
determining a compaction number of the asphalt mixture according to the Marshall compaction method for asphalt mixture according to claim 1; compacting the asphalt mixture according to the compaction number, and performing a performance test on the compacted asphalt mixture;
determining whether the pre-mixing ratio is a target mixing ratio according to whether a
first index acquired by compaction treatment and a second index acquired by the performance test meet a standard.

7. A Marshall compaction system for asphalt mixture, wherein the compaction system comprises:
a dynamic response parameters acquisition module used for acquiring dynamic response parameters of the asphalt mixture during a Marshall compaction process;
wherein the dynamic response parameters are used for characterizing an internal state of the asphalt mixture corresponding to a compaction number;
a change degree judging module used for judging whether the change degree of the dynamic response parameters is stable;
a compaction number determination module used for determining the compaction number corresponding to when the change degree of the dynamic response parameters is stable as a target compaction number.

8. A manufacturing system for asphalt mixture, wherein the manufacturing system comprises:
a pre-mixing ratio determining module used for determining a pre-mixing ratio of the asphalt mixture;
a compaction test module used for determining a compaction number of the asphalt mixture according to the Marshall compaction system of asphalt mixture according to claim 7, performing compaction treatment on the asphalt mixture according to the compaction number, and performing a performance test on the compacted asphalt mixture;
an index analysis module used for determining whether the pre-mixing ratio is a target mixing ratio according to whether a first index acquired by compaction treatment and a second index acquired by the performance test meet a standard.

9. An electronic device, wherein comprises: a memory, a processor, and a computer program stored in the memory and executable on the processor, wherein when the processor executes the computer program, the Marshall compaction method for asphalt mixture according to claim 1 is implemented.

10. An electronic device, wherein comprises: a memory, a processor, and a computer program stored in the memory and executable on the processor, wherein when the processor executes the computer program, the manufacturing method for asphalt mixture according to claim 6 is implemented.

11. A computer-readable storage medium, wherein a computer program is stored thereon, wherein when the computer program is executed by a processor, the manufacturing method for asphalt mixture according to claim 6 is implemented.

12. A computer-readable storage medium, wherein a computer program is stored thereon, wherein when the computer program is executed by a processor, the Marshall compaction method for asphalt mixture according to claim 1 is implemented.
